(19) United States
(12) Patent Application Publication
(10) Pub. No.: US 2012/0169627 A1
(43) Pub. Date: Jul. 5, 2012

(54) ELECTRONIC DEVICE AND METHOD THEREOF FOR TRANSMITTING DATA

(75) Inventors: YING-CHUAN YU, Tu-Cheng (TW); PING-YANG CHUANG, Tu-Cheng (TW)

(73) Assignee: HON HAI PRECISION INDUSTRY CO., LTD., Tu-Cheng (TW)

(21) Appl. No.: 13/158,449

(22) Filed: Jun. 12, 2011

(30) Foreign Application Priority Data
Dec. 30, 2010 (TW) 99146773

(51) Int. Cl. G06F 3/041

(52) U.S. Cl. 345/173

(57) ABSTRACT

An electronic device includes a touch screen, a storage unit storing a number of electronic files and relationships between touch contacts and functions, and a processing unit. The touch screen produces contact signals in response to user's touch contacts. The processing unit detects the according to the contact signals, determines a function corresponding to the user's touch contact according to the relationships. In addition, determines the function is a data transmitting function when the contact track of the user is slid on the touch screen toward an edge of the touch screen and the contact pressure is changed from heavy to light. The processing unit further determines an electronic file currently activated and transmits the determined electronic file, when determining the function is the data transmitting function.

### CROSS-REFERENCE TO RELATED APPLICATIONS

The subject matter disclosed in this application is related to subject matters disclosed in a copending application entitled, “ELECTRONIC DEVICE AND METHOD THEREOF FOR TRANSMITTING DATA”, filed on Dec. 26, 2010 (Atty. Docket No. US34247), and assigned to the same assignee as named herein.

### BACKGROUND

1. Technical Field

The present disclosure relates to data management and, particularly, to an electronic device with touch input and method for transmitting data based on the touch input.

2. Description of Related Art

Touch-enabled devices are in widespread use. However, if, during playback or display of content, transfer of the content to another device is needed, the current operation often needs to be abandoned, which is inconvenient.

Therefore, it is desirable to provide an electronic device and a method to overcome the described limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of an electronic device, in accordance with an exemplary embodiment.

FIG. 2 is a block diagram of the electronic device of FIG. 1, in accordance with an exemplary embodiment.

FIG. 3 is a schematic diagram illustrating a data transmission interface of the electronic device of FIG. 1.

FIG. 4 is a flowchart illustrating a method for transmitting data applied in an electronic device, such as, for example, that of FIG. 1, in accordance with an exemplary embodiment.

### DETAILED DESCRIPTION

Embodiments of the present disclosure will now be described in detail, with reference to the accompanying drawings.

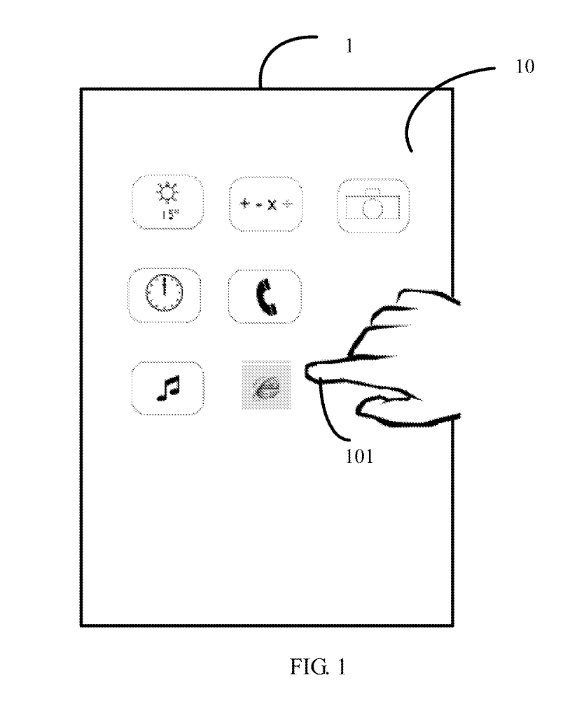

Referring to FIG. 1, an electronic device 1 capable of transmitting data is provided in accordance with an exemplary embodiment. The electronic device 1 includes a touch screen 10. The touch screen 10 displays a graphical user interface (GUI) that includes a number of icons corresponding to various operations. The operations are implemented in response to contact with the corresponding icon. In the embodiment, the touch screen 10 is a multi-point touch screen capable of producing contact signals in response to user's touch contact. In other embodiments, the electronic device 1 further includes physical controls.

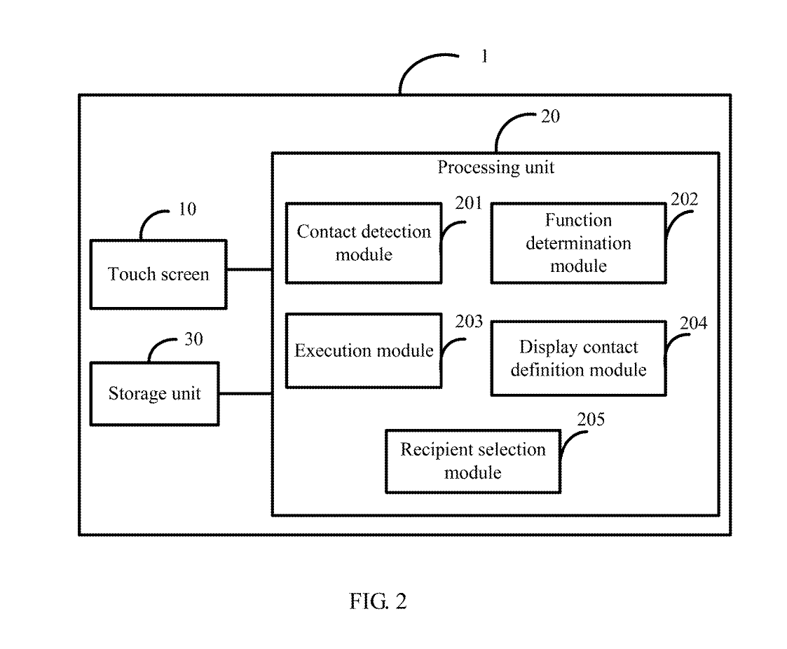

Referring to FIG. 2, the electronic device 1 further includes a processing unit 20 and a storage unit 30. The storage unit 30 stores electronic files that include, but are not limited to, audio files, videos, digital images, and text files. The storage unit 30 further stores relationships between function and touch contacts (hereinafter “touch contact-function relationships”).

The processing unit 20 includes a contact detection module 201, a function determination module 202, and an execution module 203. The contact detection module 201 receives contact signals from the touch screen 10 and detects a corresponding touch contact. The function determination module 202 determines a function corresponding to the detected touch contact according to the touch contact-function relationships. The execution module 203 executes the determined function.

The touch contact-function relationships can be provided as a system default setting or can be set by the user.

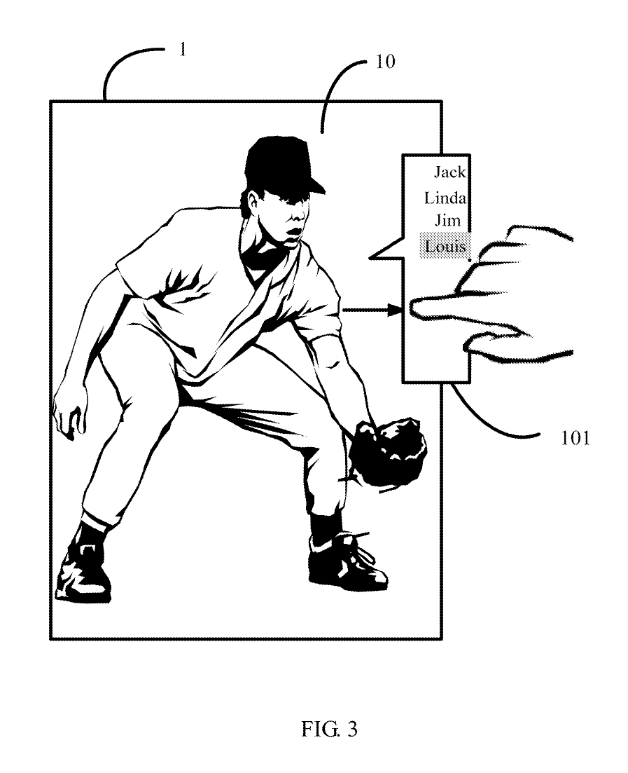

The processing unit 20 further includes a display content determination module 204 and a recipient selection module 205. In the embodiment, the touch contact includes contact track and contact pressure. Referring also to FIG. 3, during displaying of an electronic file, such as an image as shown in FIG. 3, if the contact detection module 201 detects a specific touch contact whose contract track is in a particular pattern, e.g., sliding toward an edge of the touch screen 10 and whose contact pressure is changed, e.g., from heavy to light, the function determination module 202 determines the function corresponding to the specific touch contact is a data transmitting function, based on the touch contact-function relationships. The function determination module 202 transmits a data transmitting signal to the display content determination module 204 and the recipient selection module 205 respectively. The display content determination module 204 registers the currently active electronic file (namely the display content determination module determines that the currently active electronic file is the file to be transmitted, including determining the file path, size of the file etc.), and the recipient selection module 205 directs the touch screen 10 to display a recipient list stored in the storage unit 30. In the embodiment, the outside edge of the touch screen 10 can be one of an upper edge, a right edge, a left edge, and a lower edge of the touch screen 10.

As shown in FIG. 3, the recipient selection module 205 transmits a sending signal to the execution module 203 after at least one recipient is selected. The execution module 203 transmits the electronic file determined by the display content determination module 204 to the at least one selected recipient when receiving the sending signal. In the embodiment, the recipient list includes all of the contacts of the electronic device 1. In other embodiments, the recipient list only includes some of the contacts preselected by the user. In the embodiment, the recipient list displayed on the touch screen is in a form of a dialog box.

Therefore, in the embodiment, when the user enjoys one electronic file and wants to share the electronic file with other people, he/she can transmit the electronic file to the selected people by touching the touch screen 10 directly.

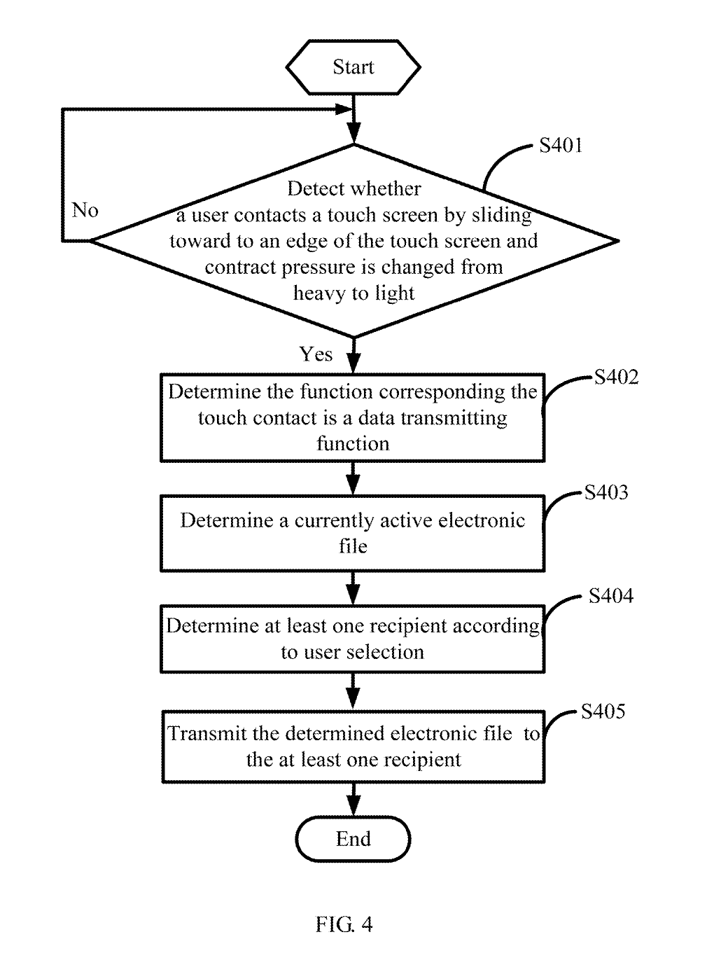

FIG. 4 is a flowchart illustrating a method for transmitting data of an electronic device such as, for example, that of FIG. 1. In step S401, the touch contact detection module 101 detects whether the contact track of the user is sliding on the touch screen 10 toward an edge of the touch screen 10 and the contact pressure is changed from heavy to light.

If not, the process returns to step S401, if yes, in step S402, the function determination module 202 determines the function corresponding the touch contact is a data transmitting function.

In step S403, the display content determination module 204 determines the currently active electronic file.

In step S404, the recipient selection module 205 determines that at least one recipient receives the electronic file according to the selection of the user. In detail, the recipient selection module 205 directs the touch screen 10 to display a recipient list for selection, and determines at least one recipient according to the selection of the user from the recipient list.

In step S505, the execution module 203 transmits the electronic file determined by the display content determination module 204 to the at least one recipient determined by the recipient selection module 205.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
a touch screen, configured to produce contact signals in response to user's touch contacts, wherein each touch contact comprises contact track and contact pressure;
a storage unit for storing a plurality of electronic files and relationships between touch contacts and functions of the electronic device; and
a processing unit comprising:
a contact detection module configured to detect a user's touch contact according to the contact signals;
a function determination module configured to determine a function corresponding to the user's touch contact according to the relationships between touch contacts and functions of the electronic device, and determine the function is a data transmitting function when the contact track of the user's touch contact is sliding toward an edge of the touch screen and the contact pressure of the user's touch contact is changed from heavy to light, and produce a data transmitting signal;
a display content determination module configured to determine an electronic file currently activated when receiving the data transmitting signal;
an execution module configured to execute the function determined by the function determination module, and transmit the currently active electronic file determined by the display content determination module when the function determined by the function determination module is the data transmitting function.

2. The electronic device according to claim 1, wherein the processing unit further comprises a recipient selection module configured to determine at least one recipient according to the user's selection; and the execution module transmits the electronic file determined by the display content determination module to the at least one recipient determined by the recipient selection module when the function determined by the function determination module is the data transmitting function.

3. The electronic device according to claim 2, wherein the recipient selection module directs the touch screen to display a recipient list for selection, and determines the at least one recipient according to the user's selection when receiving the data transmitting signal.

4. The electronic device according to claim 3, wherein the recipient list includes all of contacts of the electronic device.

5. The electronic device according to claim 3, wherein the recipient list includes some of the contacts of the electronic device preselected by the user.

6. The electronic device according to claim 3, wherein the recipient list displayed on the touch screen is in a form of a dialog box.

7. The electronic device according to claim 1, wherein the touch screen is a multi-point touch screen.

8. A method for transmitting data of an electronic device, the electronic device comprises a touch screen and a storage unit storing electronic files, the method comprising:
detecting a user's contact track and contact pressure;
determining the function is a data transmitting function if the contact track of the user is sliding on the touch screen toward an edge of the touch screen and the contact pressure is changed from heavy to light;
determining an electronic file displayed on the touch screen; and
transmitting the electronic file.

9. The method according to claim 8, wherein the step “transmitting the electronic file” comprises:
determining at least one recipient receiving the electronic file according to user's selection; and
transmitting the electronic file to the at least one recipient.

10. The method according to claim 9, wherein the step “determining a recipient receiving the electronic file according to user's selection” comprises:
controlling the touch screen to display a recipient list;
determining the at least one recipient according to the user's selection from the recipient list.
